(19) United States
(12) Patent Application Publication
(10) Pub. No.: US 2004/0070243 A1
(43) Pub. Date: Apr. 15, 2004

(54) Front seat assembly for a vehicle

(76) Inventor: Jin-Young Cha, Seoul (KR)

Correspondence Address: MORGAN, LEWIS & BOCKIUS, LLP., 3300 HILLVIEW AVENUE, PALO ALTO, CA, 94304, US

(21) Appl. No.: 10/600,072

(22) Filed: Jun. 20, 2003

(30) Foreign Application Priority Data
Oct. 11, 2002 (KR) 2002-62066

(51) Int. Cl. B60N 2/30

(52) U.S. Cl. 297/232; 297/248

(57) ABSTRACT

A front seat assembly for a vehicle configured to sit three passengers includes a driver seat and an assistant seat spaced apart by a predetermined distance. Also included is a middle seat, installed between the driver seat and the assistant seat, wherein a seat cushion is foldably installed in the seat cushion of the assistant seat and a seatback is foldably installed in a rear portion of the seat cushion of the middle seat. Furthermore, an armrest is protruded behind the seatback of the middle seat so as to allow the driver to put the driver's arm thereon when the seatback is in a folded position.

### FIELD OF THE INVENTION

Generally, the present invention relates to a front seat assembly for a recreational vehicle (RV). More particularly the present invention relates to a front seat assembly for an RV configured for three passengers wherein a driver's armrest is integrated into a seatback of the middle seat.

### BACKGROUND OF THE INVENTION

A seat of a vehicle typically includes a seat cushion for supporting the passenger's lower portion of the body, a seatback for supporting the passenger's back, and a headrest for supporting the passenger's head. In some cases, the seat further includes an armrest for allowing a passenger to put the passenger's arm thereon.

Typically, conventional seat assemblies for recreation vehicles (RV) are arranged in three rows. The seat assembly for the RV includes a front seat assembly, a first rear seat assembly, and a second rear seat assembly. The typical front seat assembly includes right and left seats installed on both sides of an inside of the RV and a middle seat. The first rear seat assembly typically includes right and left seats installed on both side of the inside of the RV and a middle seat. The second rear seat assembly is typically formed from one elongated body stretching from one side of the inside of the RV to the other side. Headrests for supporting passengers' heads are typically installed in the upper portions of seatbacks of the left and right seats of the font seat assembly, the first rear seat assembly, and the second rear seat assembly.

Typically, a seat cushion of the middle seat is foldably attached to that of the right seat (an assistant seat) and a seatback is foldably attached to the seat cushion. The middle seat, of the front seat assembly, is maintained in a folded position when not in use. This generates sufficient clearance to allow passengers to get into and out of the vehicle. If necessary, the seatback and seat cushion can be unfolded to allow a passenger to sit in the middle seat.

Typically, installed on the right side of a seatback of the driver's seat there is an armrest on which the driver's right arm can be rested. The armrest is rotatable around its lower end such that it can be raised and lowered. However, this armrest requires that the left side of the seatback of the middle seat be reduced in width, the width of the armrest, to accommodate the armrest in movement between the raised and lowered position. A passenger sitting on the middle seat may feel uncomfortable due to the narrowed seatback to accommodate the armrest of the driver's seat. Additionally, since the width of the middle seat is narrowed, a headrest for the middle seat cannot be installed on the middle seat. Accordingly, the passenger sitting on the middle seat may feel uneasy and the safety of the passenger sitting on the middle seat is compromised.

### SUMMARY OF THE INVENTION

It is an object of the present invention to provide a front seat assembly for a vehicle, in which an armrest for a driver is provided without reducing a width of a middle seat.

To accomplish the objects of the present invention, there is provided a front seat assembly for a vehicle that comprises a driver seat and an assistant seat installed in a front portion of an inside of the vehicle and spaced apart by a predetermined distance. Each of the driver seat and the assistant seat has a seat cushion for supporting a passenger's lower portion of the body and a seatback installed upright in a rear portion of the seat cushion so as to support the passenger's back. A middle seat is installed between the driver seat and the assistant seat and includes a seat cushion foldably installed in the seat cushion of the assistant seat, a seatback foldably installed in a rear portion of the seat cushion of the middle seat, and an armrest protruding behind the seatback of the middle seat to allow the driver to rest her/his arm thereon.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment(s) of the present invention and together with the detailed description serve to explain the principle of the present invention. In the drawings:

FIG. 1 is a perspective view of a front seat assembly for an RV in accordance with an embodiment of the present invention, when a seatback of a middle seat is folded; and

FIG. 2 is a perspective view of the RV front seat assembly in accordance with an embodiment of the present invention, when the seatback of the middle seat is unfolded.

### DETAILED DESCRIPTION OF THE PREFERRED EMBODIMENTS

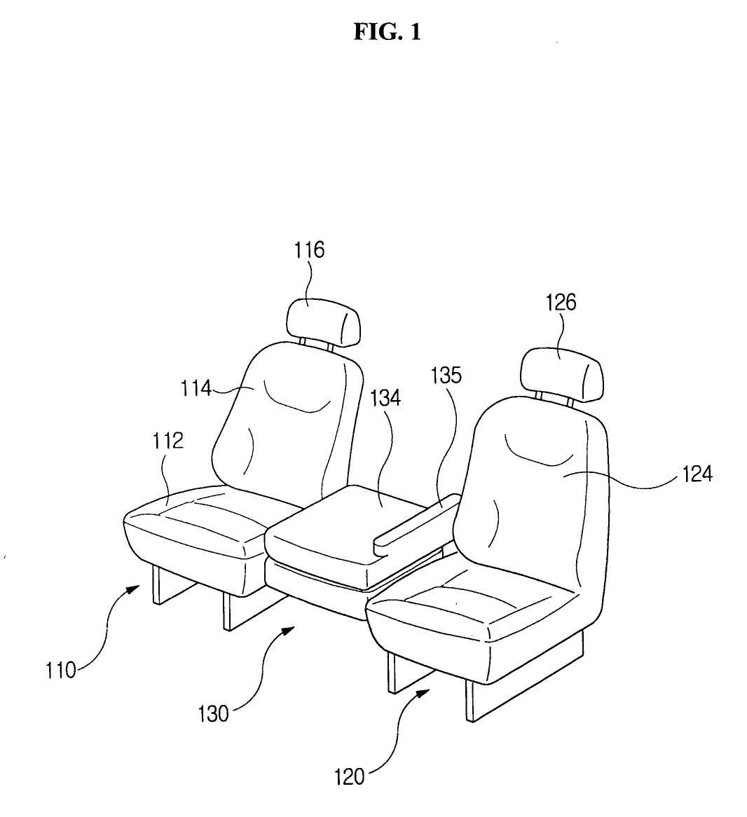

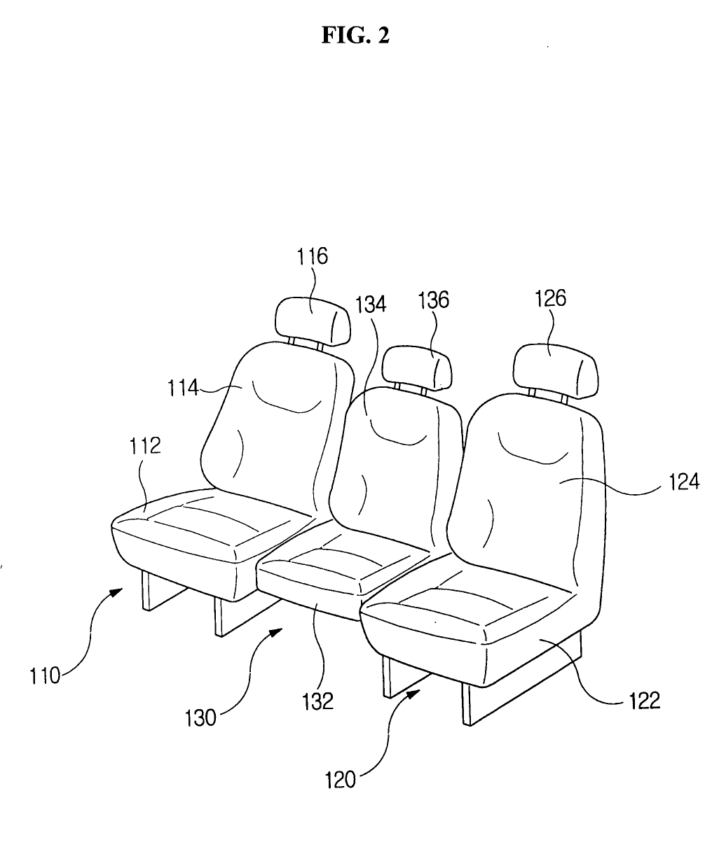

FIGS. 1 and 2 are perspective views of a front seat assembly in accordance with an embodiment of the present invention. FIG. 1 shows a seatback 134 of a middle seat 130 in a folded position and FIG. 2 shows a seatback 134 of the middle seat 130 in an unfolded position.

As shown, the front seat assembly of the present invention includes a driver seat 120, an assistant seat 110 and a middle seat 130. Each of the driver seat 120 and the assistant seat 110 is installed in its own floor panel and includes seat cushions 122 and 112 for supporting a passenger's lower portion of the body, seatbacks 124 and 114 installed upright near a rear portion of the seat cushions 122 and 112, respectfully, to support the passenger's back, and headrests 126 and 116 in upper portions of the seatbacks 124 and 114, respectfully, to support passenger's head.

The middle seat 130 is installed between the driver seat 120 and the assistant seat 110 and includes a seat cushion 132, a seatback 134 and a headrest 136. The seat cushion 132 of the middle cushion 130 is foldably installed in a side portion of the assistant seat 110. The seatback 134 is foldably installed in a rear portion of the seat cushion 132.

As shown in FIG. 1, an armrest 135 is formed behind the seatback 134 so that the driver can rest her/his arm thereon. It is preferred that the armrest 135 is formed together with the seatback 134 in one body. More preferably, an armrest (not shown) for a passenger, sitting on the assistant seat 110, is also formed behind the seatback 134 of the middle seat 130 such that the passenger can rest their left arm thereupon. Consequently, the width of the seatback 134 of the middle seat 130 can be substantially a full seat width. Also, as shown in FIG. 2, a headrest 136 is installed in the upper portion of the seatback 134 of the middle seat 130.

In accordance with an embodiment of the front seat assembly constructed as above, if there is no passenger sitting on the middle seat 130, the seat cushion 132 is unfolded and the seatback 134 is folded, as shown in FIG. 1. In this configuration, the driver can rest her/his right arm on the armrest 135 formed behind the seatback 134 of the middle seat 130. Furthermore, in a preferred embodiment, the assistant can rest his/her left arm on the armrest (not shown) formed behind the seatback 134 of the middle seat 130. If a third seat is needed to accommodate another passenger, the middle seatback 134 is unfolded as shown in FIG. 2.

The forgoing embodiment is merely exemplary and is not to be construed as limiting the present invention. The present teachings can be readily applied to other types of apparatuses. The present invention can also apply to the second row seat. The description of the present invention is intended to be illustrative, and not to limit the scope of the claims. Many alternatives, modifications, and variations will be apparent to those skilled in the art.

What is claimed is:

1. A front seat assembly for a vehicle, comprising:
a driver seat and an assistant seat installed in a front portion of an inside of the vehicle and spaced apart by a predetermined distance, each of the driver seat and the assistant seat having a seat cushion for supporting a passenger's lower portion of the body and a seatback installed upright near a rear portion of the seat cushion so as to support the passenger's back; and
a middle seat installed between the driver seat and the assistant seat, including a seat cushion foldably installed in the seat cushion of the assistant seat, a seatback foldably installed in a rear portion of the seat cushion of the middle seat, and an armrest protruded behind the seatback of the middle seat so as to allow the driver to put the driver's arm thereon.

2. The front seat assembly according to claim 1, wherein the middle seat further includes a headrest for supporting a passenger's head, the headrest being installed in an upper portion of the seatback.

3. The front seat assembly according to claim 1 or 2, wherein the middle seat further includes an armrest for the assistant seat, the armrest being protruded behind the seatback of the middle seat on a side of the assistant seat so as to allow a passenger sitting on the assistant seat to put the passenger's arm thereon.

4. A seat assembly for a vehicle, comprising:
a driver's seat;
a passenger's seat; and
a middle seat comprising:
a seat cushion foldably retractable into said passengers seat;
a seatback foldably retractable into said seat cushion;
a head rest foldably retractably into said seatback; and
an armrest configured and dimensioned on a back side of said seatback such that a driver's right arm can be rested thereupon when said seatback is in a folded position.

5. The seat assembly of claim 4, further comprising another armrest configured and dimensioned on the back side of said seatback such that a passenger's left arm can be rested thereupon when said seatback is in a folded position.

6. A seat assembly for a vehicle, comprising:
two seats, each comprising a seat cushion, seatback, and headrest portions configured and dimensioned to receive passengers of a vehicle and separated by a middle seat wherein said middle seat comprises;
a seat cushion;
a seatback foldably attached to said seat cushion and configured and dimensioned to receive a passenger when unfolded;
a headrest foldably attached to said seatback; and
an armrest configured and dimensioned on a back side of said seatback such that when said seat back is in a folded position said armrest is accessible to a passenger in an adjacent seat.
